(19) United States
(12) Patent Application Publication
(10) Pub. No.: US 2025/0329964 A1
(43) Pub. Date: Oct. 23, 2025

(54) ANTI-FALSE-TOUCH PULL TIE CONNECTOR

(71) Applicant: ZHEJIANG ZHAOLONG INTERCONNECT TECHNOLOGY CO., LTD., ZHEJIANG (CN)

(72) Inventors: Chun-Hsu CHEN, ZHEJIANG (CN); Shi-Jung CHEN, ZHEJIANG (CN); Chun-Hua CHEN, ZHEJIANG (CN)

(21) Appl. No.: 19/066,182

(22) Filed: Feb. 28, 2025

(30) Foreign Application Priority Data
Apr. 18, 2024 (TW) 113203855

(51) Int. Cl. H01R 13/633

(52) U.S. Cl. CPC H01R 13/6335

(57) ABSTRACT

An anti-false-touch pull tie connector connected to a pull tie, includes: an insulation body having a conductive tongue piece; a sheathing case sheathing the insulation body; a lock component disposed in the insulation body and having a passive part, the passive part is connected to the pull tie; and an anti-false-touch structure disposed in the insulation body and having an anti-touch cover, the anti-touch cover correspondingly shields the passive part. Accordingly, an advantage of preventing the passive part from being falsely touched by an external force is provided, and a situation of being accidentally and falsely unlocked is avoided.

### BACKGROUND OF THE DISCLOSURE

### Technical Field

The present disclosure relates to a pull tie connector, especially to an anti-false-touch pull tie connector.

### Description of Related Art

A related-art pull tie connector utilizes a pull tie to pull a lock structure to react, and a buckle member of the lock structure is released from a buckle unit of an engage connector, thus the pull tie connector is released from the engage connector.

However, a passive of the lock structure of the related-art pull tie connector, which is used to be pulled by the pull tie, is directly exposed to the exterior, and the passive part is often disposed at a location easily to be touched by an external force, thus the external force may be accidentally applied to the passive part to make to pull tie connector be released from the engaged. As such, the aforesaid disadvantages shall be improved.

Accordingly, the applicant of the present disclosure has devoted himself for improving the mentioned shortages.

### SUMMARY OF THE INVENTION

The present disclosure provides an anti-false-touch pull tie connector, which has an advantage of preventing a passive part of a lock component from being falsely touched by an external force.

Accordingly, the present disclosure provides an anti-false-touch pull tie connector connected to a pull tie, which includes: an insulation body having a conductive tongue piece; a sheathing case sheathing the insulation body; a lock component disposed on the sheathing case and having a passive part, the passive part is connected to the pull tie, and the passive part is driven by the pull tie; and an anti-false-touch structure disposed in the insulation body and having an anti-touch cover, and the anti-touch cover correspondingly shields the passive part.

In comparison with related art, the present disclosure has advantageous features as follows. Through the anti-touch cover being disposed, the passive part of the lock component is prevented from being falsely touched by the external force, thus a situation of being accidentally and falsely unlocked is avoided.

### BRIEF DESCRIPTION OF THE DRAWINGS

FIG. 1 is a perspective view showing the pull tie connector according to the present disclosure;

FIG. 2 is another perspective view showing the pull tie connector according to the present disclosure;

FIG. 3 is a perspective exploded view showing the pull tie connector according to the present disclosure;

FIG. 4 is an enlarged perspective exploded view showing a portion of the components of the pull tie connector according to the present disclosure;

FIG. 5 is an enlarged perspective exploded view showing the anti-false-touch structure of the pull tie connector according to the present disclosure;

FIG. 6 is a cross-sectional view showing the pull tie connector being inserted in the engage connector and being buckled and locked according to the present disclosure; and

FIG. 7 is a cross-sectional view showing the pull tie connector being pulled by the tie of FIG. 6 to be unlocked according to the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

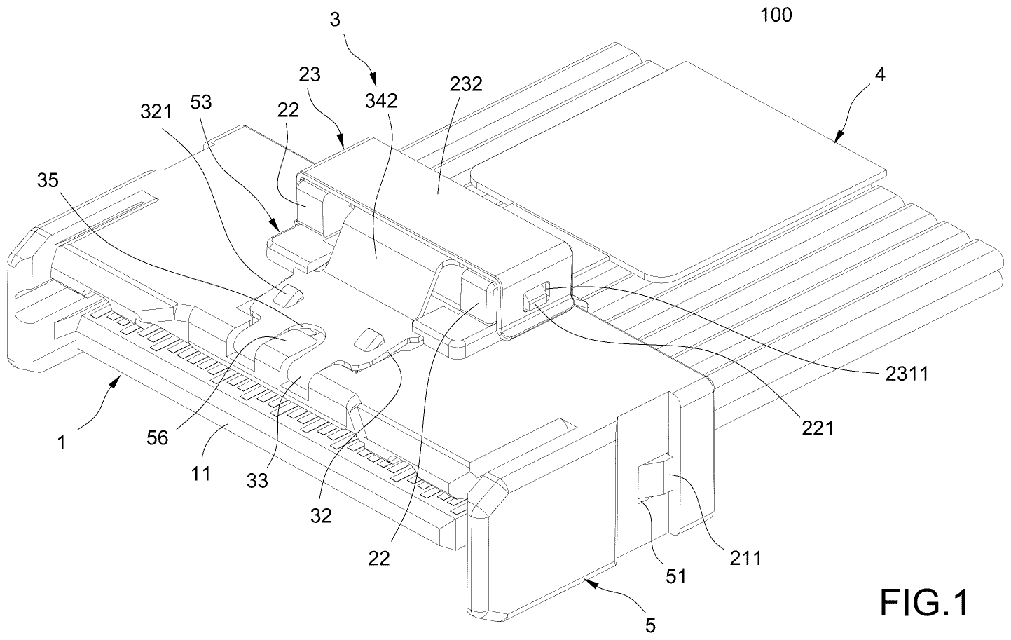

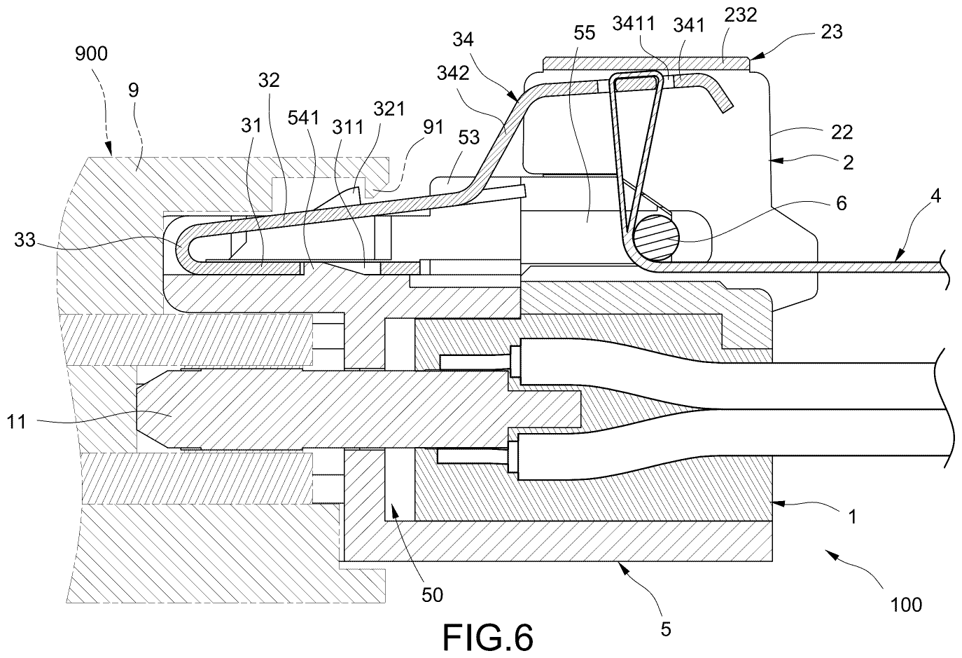

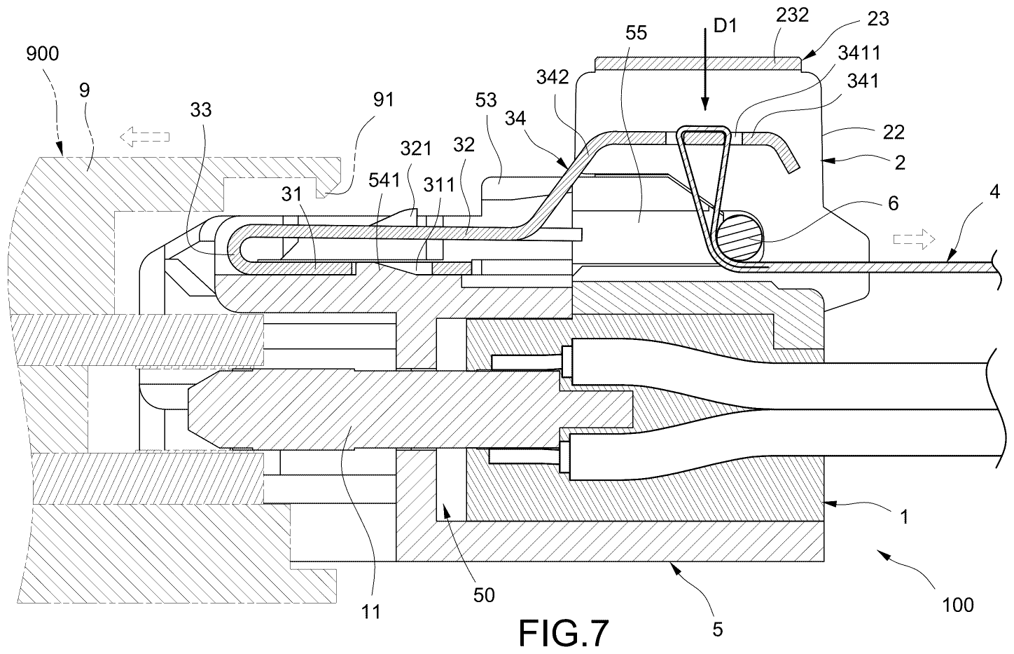

The present disclosure provides an anti-false-touch pull tie connector, which is connected to a pull tie 4 as shown in FIG. 1. When the anti-false-touch tie connector (hereinafter defined as a pull tie connector 100) is inserted in an engage connector 900 as shown in FIG. 6, and a mutual locking status is formed after the insertion, the mutual locking status is terminated by pulling the pull tie 4. Please refer to FIG. 6 and FIG. 7, the pull tie connector 100 of the present disclosure is inserted in the aforesaid engage connector 900 along an insertion direction (not shown in figures).

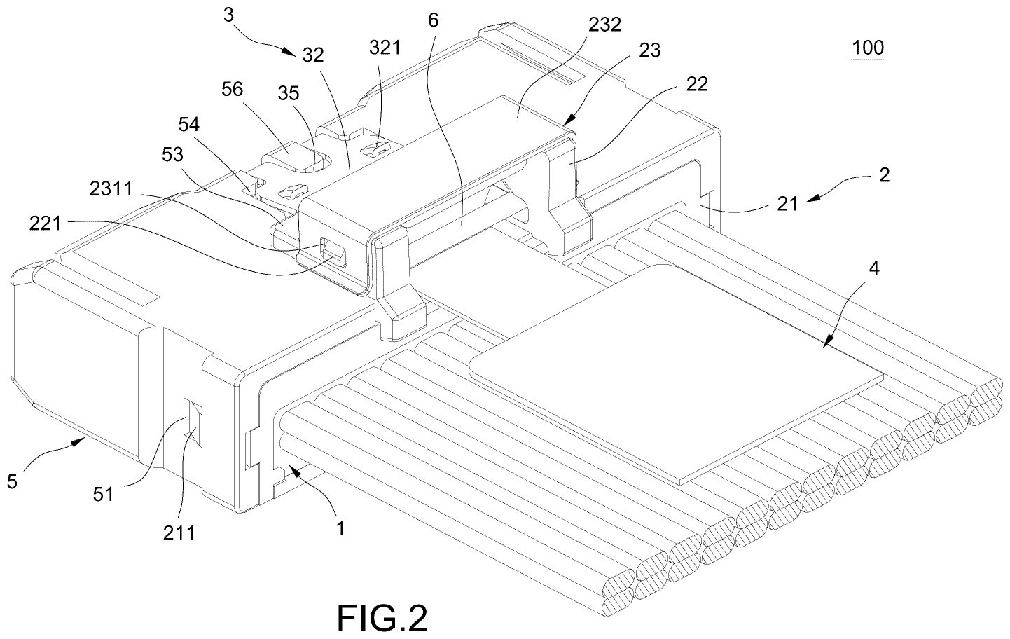

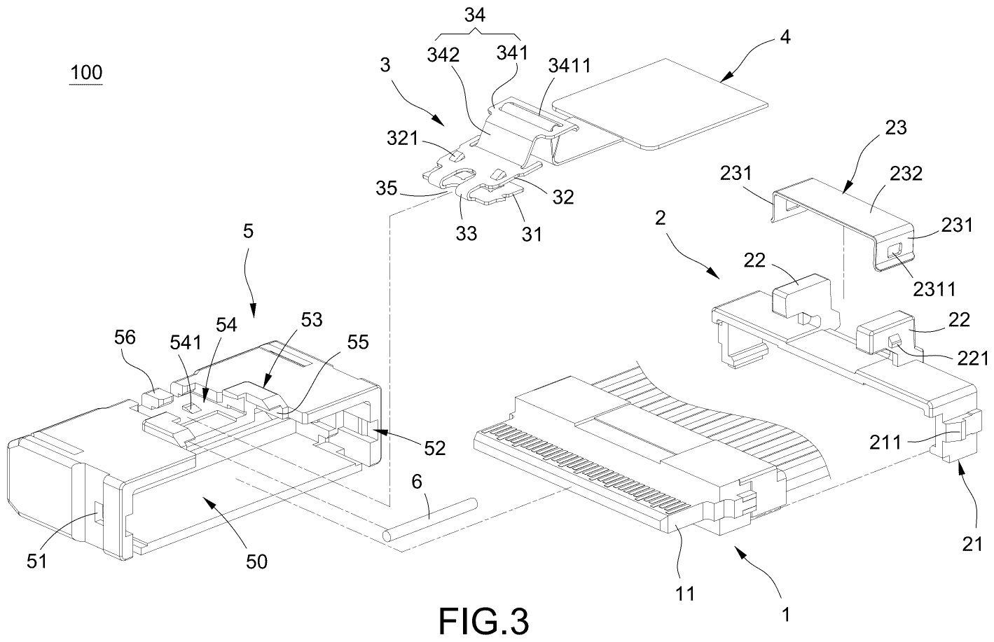

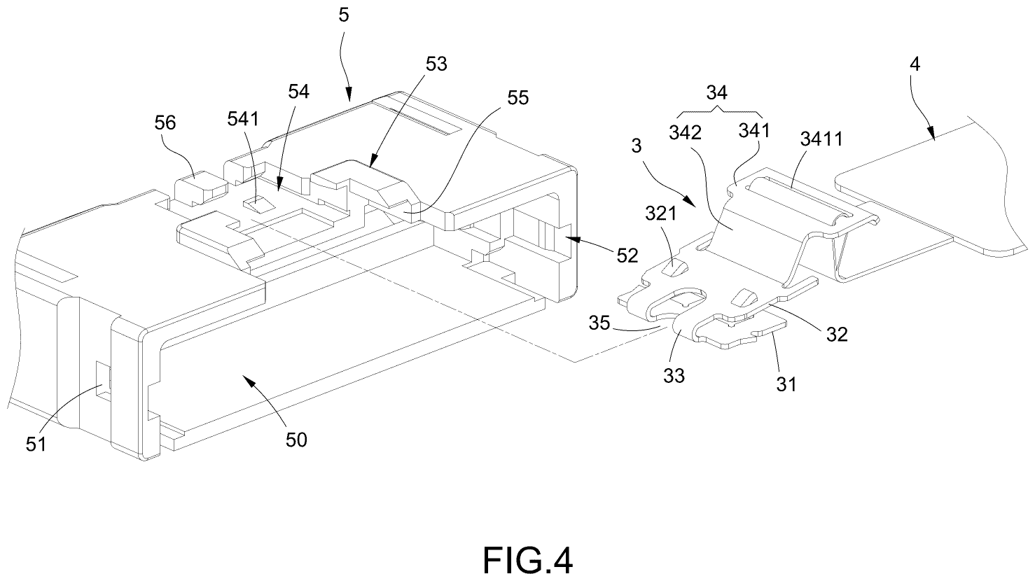

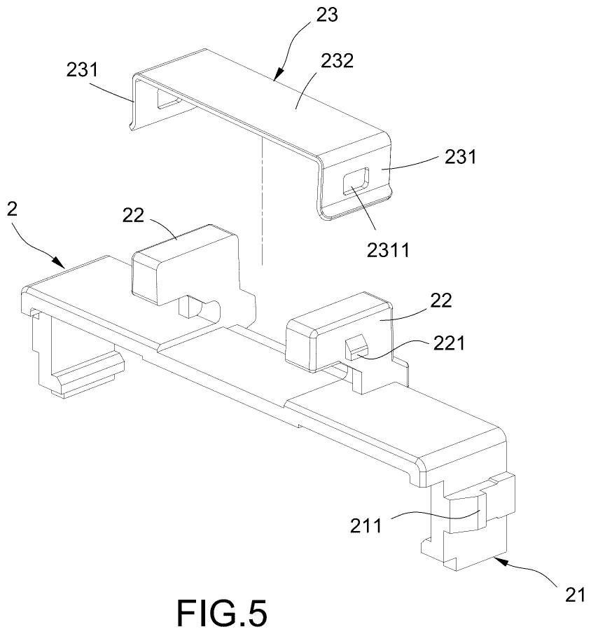

Please refer from FIG. 1 to FIG. 6, the pull tie connector 100 includes an insulation body 1, a lock component 3, a sheathing case 5 and an anti-false-touch structure 2. In some embodiments, the pull tie connector 100 further includes a rod member 6.

The insulation body 1 has a conductive tongue piece 11 protruded along the insertion direction. The conductive tongue piece 11 has a plurality of conductive connecting fingers (not shown in figures).

The sheathing case 5 sheathes the insulation body 1, and the sheathing case 5 encloses the insulation body 1 after the sheathing process. Details are provided as follows. The sheathing case 5 has an assembly space 50 and two slide slots 52 communicating with the assembly space 50. The two slide slots 52 are disposed one two opposite inner walls of the sheathing case 5 and spaced apart. Two sides of the sheathing case 5 are disposed with a corresponding assembly unit 51. The corresponding assembly unit 51 may be penetrated hole penetrating the sheathing case 5 to communicate with the assembly space 50. The sheathing case 5 is longitudinally disposed with a convex platform 53 and a recessed part 54 along a direction perpendicular to the insertion direction. Two inner walls of the convex platform 53 are respectively disposed with a lateral slot 55. The two lateral slots 55 are oppositely arranged and spaced apart. One side of the recessed part 54 is disposed with a check unit 541. The sheathing case 5 has a protrusion 56 located at another location of the recessed part 54.

The lock component 3 is disposed on the sheathing case 5 and has a passive part 34. The passive part 34 is connected to the aforesaid pull tie 4, thus the passive part 34 is driven to act through a user pulling the pull tie 4.

Details are provided as follows. The lock component 3 includes a support part 31, an active part 32, a bent part 33 and the passive part 34. The bent part 33 is connected between one end of the support part 32 and one end of the active part 32, thus the aforesaid three parts are mutually connected to form a horizonal-V shape as shown in FIG. 6. The active part 32 has at least one buckle member 321. The passive part 34 is connected to another end of the active part 32. In some embodiments, the passive part 34 has a main segment 341 and an inclined segment 341 to make a height of a passive location of the passive part 34 be higher than the active part 32 about a certain distance. The inclined segment 342 is obliquely connected (or vertically connected) to the main segment 341 and another end of the active part 32, thus the main segment 341 is higher than the active part 32 about a certain distance. As such, when the main segment 341 is pulled by the pull tie 4, the active part 32 is linked to elastically swing with a greater level relative to the support part 31 with the bent part 31 being served as an axle, thus the buckle member 321 is displaced and an unlocked status is formed. The main segment 341 is connected to the pull tie 4 via a penetrated hole 3411, but here is not intended to be limiting. The main segment 341 is spaced apart relative to a location where the bent part 33 is disposed on a linear line along the insertion direction.

What shall be addressed is that a pull direction D1 is defined on the lock component 3 with respect to the main segment 341 of the passive part 34, as shown in FIG. 7. The pull direction D1 and the aforesaid insertion direction are crossed (or vertical or substantially vertical).

When being assembled, the lock component 3 is fastened on the sheathing case 5 by the support part 31 being at a location corresponding to the recessed part 54. In some embodiments, the support part 31 has a latch part 311. The latch part 311 of the support part 31 is latched at the check unit 541 to make the support part 31 be fastened and supported in the sheathing case 5. Moreover, the aforesaid rod member 6 moveably crosses between the two lateral slots 55 of the convex platform 53, and the pull tie 4 winds around the rod member 6 to be connected to the main segment 341, thus the pull direction D1 of the main segment 341 and the insertion direction being crossed (or vertical or substantially vertical) is altered relative to the pull tie 4.

In some embodiments, the lock component 3 further includes a notch 35, and the protrusion 56 is mounted in the notch 35 after the lock component 3 is assembled, thus the lock component 3 is formed with a positioned or position limited status, and the support part 31 is fastened between the protrusion 56 and the check unit 541 in the insertion direction.

The anti-false-touch structure 2 is disposed on the insulation body 1 and has an anti-touch cover 23. The anti-touch cover 23 correspondingly shields the main segment 341, in other words the anti-touch cover 23 shields the main body 341 of the passive part 34 in the pull direction D1.

Details are provided as follows. The anti-false-touch structure 2 includes a frame 21 and the aforesaid anti-touch cover 23. The frame 21 is disposed on the insulation body 1 and has two connection columns 22. The frame 21 further has two assembly units 211 oppositely arranged and spaced apart. The frame 21 slides in each of the slide slots 52 of the sheathing case 5 through each of the assembly units 211, each of the assembly units 211 is correspondingly latched with each of the corresponding assembly units 51 after the sliding process, thus the frame 21 is fastened with the sheathing case 5. Thw two connection columns 22 are vertically protruded from the frame 21 and spaced apart in the pull direction D1, thus the main segment 341 is located between the two connection columns 22.

The anti-touch cover 23 is disposed on the frame 21 and has a cover part 232 and two connection parts 231. The cover part 232 bridges between one ends of the two connection parts 231. Each of the connection parts 231 has a fasten unit 2311. When the two connection parts 231 respectively abut against one side of each of the two connection columns 22, the fasten unit 2311 of each of the connection parts 231 is correspondingly latched with a corresponding fasten unit 221 of each of the connection columns 22, thus the anti-false-touch structure 2 is assembled. At this moment, the cover part 232 shields the main segment 341, and an effect of preventing the main segment 341 from being falsely touched is provided.

Please refer to FIG. 6, when the pull tie connector 100 of the present disclosure is correspondingly inserted in a housing 9 of the engage connector 900, the buckle member 321 of the lock component 3 is mutually buckled with a buckle unit 91 of the housing 9, thus the pull tie connector 100 is prevented from being reversely pulled out.

Please refer to FIG. 6 and FIG. 7, when the pull tie connector 100 needs to be reversely pulled out, the user pulls the pull tie 4 to make the pull tie 4 pull the main segment 341 of the lock component 3 along the pull direction D1, the inclined segment 342 links the active part 32 to elastically swing relative to the support part 31, the buckle member 321 is released from the buckle unit 91 after the active part 32 has elastic reflectively swung, thus an unlocked operation is achieved.

Accordingly, the pull tie connector 100 of the present disclosure is provided with an advantage of preventing the main segment 341 of the passive part 34 from being falsely touched by the external force through the anti-touch cover 23, thus a situation of being accidentally and falsely unlocked is avoided.

While this disclosure has been described by means of specific embodiments, numerous modifications and variations may be made thereto by those skilled in the art without departing from the scope and spirit of this disclosure set forth in the claims.

What is claimed is:

1. A pull tie connector, connected to a pull tie, the pull tie connector comprising:
an insulation body, comprising a conductive tongue piece disposed protrusively;
a sheathing case, adapted to sheathe the insulation body;
a lock component, disposed on the sheathing case and comprising a passive part, wherein the passive part is connected to and driven by the pull tie; and
an anti-false-touch structure, disposed on the insulation body and comprising an anti-touch cover, wherein the anti-touch cover correspondingly shields the passive part.

2. The pull tie connector according to claim 1, wherein the lock component comprises a pull direction with respect to the passive part, and the anti-touch cover shields the passive part on the pull direction.

3. The pull tie connector according to claim 1, wherein the anti-false-touch structure comprises a frame and the anti-touch cover, wherein, the frame is disposed on the insulation body, the anti-touch cover is disposed on the frame, and the passive part is disposed between the anti-touch cover and the frame.

4. The pull tie connector according to claim 3, wherein the frame comprises two connection columns, the passive part is disposed between the two connection columns, the anti-touch cover comprises a cover part and two connection parts, the two connection parts are connected to the two connection columns, and the cover part bridges between one ends of the two connection parts and shields the passive part.

5. The pull tie connector according to claim 1, wherein the lock component comprises a support part, an active part, a bent part and the passive part, the bent part is connected between one end of the support part and one end of the active part, the passive part is connected to another end of the active part, the support part is fastened with the sheathing case, the active part elastically swings relative to the support part with the bent part being served as an axle, and the active part comprises at least one buckle member.

6. The pull tie connector according to claim 5, wherein the passive part comprises a main segment and an inclined segment, the inclined segment is obliquely connected between the main segment and the another end of the active part, and the main segment is linearly spaced apart with the bent part.

7. The pull tie connector according to claim 1, wherein the sheathing case comprises two lateral slots defined spacedly, and a rod member moveably disposed across the two lateral slots.
